(19) United States
(12) Patent Application Publication
(10) Pub. No.: US 2004/0267778 A1
(43) Pub. Date: Dec. 30, 2004

(54) Media foundation topology application programming interface

(75) Inventors: Eric Rudolph, Woodinville, WA (US); Kirt Debique, Seattle, WA (US); Geoffrey T. Dunbar, Kirkland, WA (US); Sohail Baig Mohammed, Redmond, WA (US); Brian D. Crites, Redmond, WA (US); Mei L. Wilson, Redmond, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA

(21) Appl. No.: 10/692,639

(22) Filed: Oct. 24, 2003

Related U.S. Application Data
(63) Continuation-in-part of application No. 10/608,868, filed on Jun. 27, 2003.

(51) Int. Cl. G06F 7/00

(52) U.S. Cl. 707/100

(57) ABSTRACT

An application programming interface for a multimedia processing system creates a topology symbolically providing data flow information. A method provides a topology interface including receiving a plurality of media parameters identifying at least an identifier, a node type, a data type and a duration, and in response, creating a topology capable of being passed to a media processor as an extensible symbolic representation of an intended media flow. A computer-readable medium stores a topology function includes a first input parameter representing a unique identifier, a second input parameter representing a state of a topology, a third parameter representing a descriptor for the topology, a fourth parameter representing one or more characteristics about a node of the topology, and executable instructions adapted to provide a topology capable of being passed to a media processor as an extensible symbolic representation of an intended media flow calculated based on at least one of the input parameters.

### FIELD OF THE INVENTION

This invention relates generally to computer systems and, more particularly, relates to an application programming interface for a topology in a media playback system.

### BACKGROUND OF THE INVENTION

As the abilities of computers expand into entertainment genres that once required separate electronic components, increased efficiency and user-friendliness is desirable. One solution is Microsoft's® DirectShow®, which provides playback of multimedia streams from local files or Internet servers, capture of multimedia streams from devices, and format conversion of multimedia streams. DirectShow® enables playback of video and audio content of file types such as MPEG, Apple® QuickTime®, Audio-Video Interleaved (AVI), WAV, Windows Media Audio (WMA) and Windows Media Video (WMV).

DirectShow® includes a system of pluggable filter components. Filters are objects that support DirectShow® interfaces and can operate on streams of data by reading, copying, modifying and writing data to a file. The basic types of filters include a source filter, which takes the data from some source, such as a file on disk, a satellite feed, an Internet server, or a VCR, and introduces it into the filter graph. A filter graph is an object which controls the streaming state of a collection of filters. There is also a transform filter, which converts the format of the data, and a rendering filter, which renders the data, for example to a display device or to a file on disk. Any filter which is not a source or sink of data is considered a “transform” filter. Other types of transform filters included in DirectShow® include effect filters, which add effects without changing the data type, and parser filters, which understand the format of the source data and know how to read the correct bytes, create times stamps, and perform seeks.

Each filter contains objects called “pins” that are used to connect to other filters. When filters are connected using the pins, a filter graph is created. Note there is a distinction between a “filter graph” which is the concept of a group of connected filters, and a “Filter Graph” which is the object you create in DirectShow® that controls the group of connected filters, the “filter graph”. The “Filter Graph” is more correctly called a filter graph manager. To control the data flow and connections in a filter graph, DirectShow® includes a filter graph manager. The filter graph manager assists in assuring that filters are connected in the proper order. Filters must be linked appropriately. For example, the filter graph manager must search for a rendering configuration, determine the types of filters available, link the filters appropriate for a given data type and provide an appropriate rendering filter.

Although DirectShow® was an improvement in the field, DirectShow® has limitations. For example, DirectShow® requires the use of pins and has limited configuration flexibility. What is needed is expanded flexibility and modularity of a multimedia system.

### BRIEF SUMMARY OF THE INVENTION

An application programming interface for a multimedia processing system provides flexibility and modularity by providing interfaces for a system that separate the data flow information from the maintaining of stream state of multimedia components. The interfaces apply to a system that includes a media processor component configured to process received media data, a media session to determine a timeline for events to occur for performing media processing and a topology loader component to load a topology that describes a flow for the received media data to enable processing via an extensible symbolic abstraction of media objects, the topology loader configured to ensure that events described in the topology occur. The interfaces allow core layer components such as media sink components to determine a media stream for output from the multimedia processing system and a media source component coupled to supply media data for processing. The topology created in the system symbolically provides data flow information, independent of maintaining a streaming state of control information. Thus, a topology enables dynamic adding and removing multimedia components from the topology and is the extensible symbolic abstraction of media objects that do not need instantiation.

According to embodiments, a topology can have several types of nodes such as a segment topology node configured to provide an encapsulated topology that can be inserted and deleted from a topology; a tee node to provide a primary and secondary output streams and to respond to logic dictating a discardability of data output from the primary and the secondary output stream; a demultiplexer node configured to split media into different types of media from a combined input.

A method provides a topology interface including receiving a plurality of media parameters identifying at least an identifier, a node type, a data type and a duration, and in response, creating a topology capable of being passed to a media processor as an extensible symbolic representation of an intended media flow.

A computer readable medium on which is stored a topology function includes a first input parameter representing a unique identifier, a second input parameter representing a state of a topology, a third parameter representing a descriptor for the topology, a fourth parameter representing one or more characteristics about a node of the topology, and executable instructions adapted to provide a topology capable of being passed to a media processor as an extensible symbolic representation of an intended media flow calculated based on at least one of the input parameters.

Additional features and advantages of the invention will be made apparent from the following detailed description of illustrative embodiments, which proceeds with reference to the accompanying figures.

### BRIEF DESCRIPTION OF THE DRAWINGS

While the appended claims set forth the features of the present invention with particularity, the invention, together with its objects and advantages, can be best understood from the following detailed description taken in conjunction with the accompanying drawings of which:

FIG. 1 is a block diagram generally illustrating an exemplary computer system on which the present invention resides.

FIG. 2 is block diagram of a media processing system in accordance with an embodiment of the present invention.

FIG. 3 is a block diagram illustrating a topology in accordance with an embodiment of the present invention.

FIG. 4 is a block diagram illustrating a tee node in accordance with an embodiment of the present invention.

FIG. 5 is a block diagram illustrating a splitter node in accordance with an embodiment of the present invention.

FIG. 6 is a block diagram illustrating a timeline source node and topologies in accordance with an embodiment of the present invention.

FIG. 7 is a block diagram illustrating effects possible on a timeline in accordance with an embodiment of the present invention.

FIG. 8 is a block diagram illustrating different topologies at different times associated with the timeline shown in FIG. 7 in accordance with an embodiment of the present invention.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

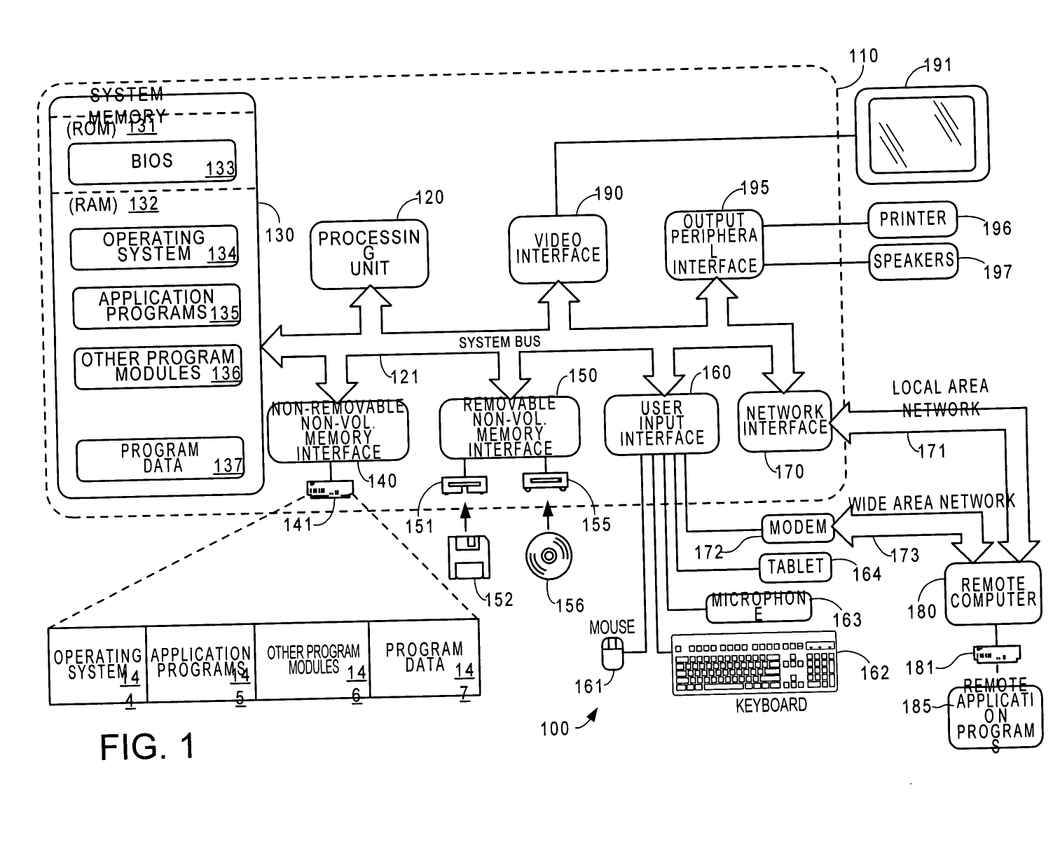

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components, including the system memory to the processing unit 120. The system bus 121 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer readable media. Computer readable media can be any available media that can be accessed by the computer 110 and includes both volatile and nonvolatile media as well as removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 which are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers hereto illustrate that, at a minimum, they are different copies. A user may enter commands and information into the computer 10 through input devices such as a tablet, or electronic digitizer, 164, a microphone 163, a keyboard 162 and pointing device 161, commonly referred to as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 197 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 10, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, in the present invention, the computer system 110 may comprise the source machine from which data is being migrated, and the remote computer 180 may comprise the destination machine. Note, however, that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. Those skilled in the art will appreciate that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that one or more of the acts and operations described hereinafter may also be implemented in hardware.

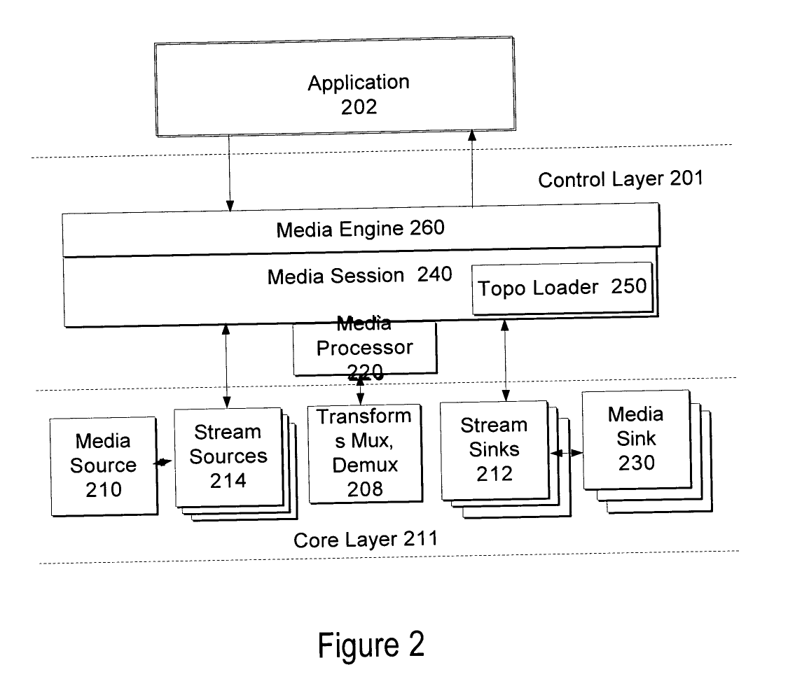

Referring to FIG. 2, a Media Foundation architecture is described. Media Foundation is Microsoft's next generation multimedia architecture. Media Foundation is a componentized architecture. As shown, Media Foundation includes core layer 211 components that are responsible for some basic unit of functionality in Media Foundation, and Control layer 201 components, responsible for performing a more general tasks using the underlying Core component.

Core layer 211 components include media sources 210 and stream sources 214, which provide multimedia data through a generic, well-defined interface. There are many implementations of media sources, for providing multimedia data from different multimedia file types or devices. Core layer 211 further includes transforms shown in block 208, which perform some sort of transformation operation on multimedia data through a generic, well-defined interface. Transform examples are codecs, video resizers, audio resamplers, statistical processors, color resamplers, and others. Block 208 can further include demultiplexers, which take interleaved multimedia data as an input, and separate the data into individually useful media streams of multimedia data. Demultiplexers share a common, well-defined interface, and there are many implementations for demultiplexing different types of data. Block 208 further includes multiplexers, which take individual media streams and combine them into interleaved multimedia data. Multiplexers share a common, well-defined interface, and there are many implementations for multiplexing into different types of multimedia data. Core layer 211 further includes stream sinks 212 and media sinks 230. Media Sinks 230 accept multimedia data as input through a generic, well-defined interface. There are many implementations of media sinks for performing different functions with multimedia data. For instance, writing the multimedia data to a given file type, or displaying the multimedia data on a monitor using a video card.

Control layer 201 components use the core layer 211 components to perform higher level tasks in a simpler way. Typically a control layer component will use many different core layer components for a given task. For instance, playing back a multimedia file will involve a media source to read the file from disk and parse the data, one or more transforms to decompress the compressed multimedia data, and one or more media sinks to display the multimedia data. Control layer 201 includes media engine 260, which interacts with application 202 to receive and send media streams, media session 240, media processor 220 and topology loader 250, shown within media session 240. Topology loader 250 is a control layer component responsible for describing the data flow between the core layer components. A control layer components can be configured to avoid access to the more primitive core-level components used by the control layer. Data flows through system beginning with a media source 210, flowing through the media session 240, to media processor 220 and an output at media sink 230. Media session 240 guides when events in a topology occur, and the topology loader 250 ensures that events prescribed in a topology occur. Components in a topology include media source 210 components and media sink 230 components as well as other nodes as further explained in detail below. The media foundation system 200 provides interfaces and a layout for connecting streaming media objects. The system allows a user to specify connections between generic or specified sources, transforms, and sink objects via a symbolic abstraction using a topology concept.

A topology for purposes of the present inventions is a description of media sources and core layer components/objects that are connected in a certain order. A topology describes the flow of multimedia data through the collection of components. The components referenced in a topology node can include either actual object pointers or an object if there is enough information in the topology node to be able to create the required object. A topology can include a pointer to a fully instantiated multimedia component or provide enough information to create the multimedia component. The options allow a topology to be used without fully instantiating one or more of the multimedia components, and, thus, allows a user of a topology, such as an application or media engine 260 to perform efficient resource management while still using a topology structure.

The system overcomes the limitations present in prior art multimedia systems by providing a modular system that does not require actual “core layer components” always presented, and directly physically connected. Also, this new system separates the data flow information from the actual maintaining of the streaming state of the “core layer components”, i.e., this system doesn't contain any run time streaming state. Moreover, the topology concept, according to embodiments herein, provides a node system, including source nodes, transform nodes, splitter nodes, tee nodes and segment topology nodes. A node is a representation of the data flow in and out of a given core layer component. A node in a topology represents a point at which data will be flowing in or out (or both) of a single unique core layer component. The node concept extends the prior art filter graph concept to a dynamic and extensible concept that allow switching out of nodes, and swapping nodes without affecting other nodes. Rather than a system that requires interconnectedness for functionality, the system illustrated in FIG. 2 provides an independently configurable node system with interchangeable nodes. The connections are virtual. That is, each node is initially connected symbolically without actually requiring a working (agreed upon) connection. The nodes, therefore, are an extrapolation of a possibility of a connection. No instantiation of the objects is required. Rather, a logic can apply after the symbolic connection to insert necessary filters and make connections. Overhead and associated components are inherently loaded once the symbolic connections are made. Because the connections are symbolic, the components can be shared or instantiated multiple times. In an embodiment, two partial topologies can reference a same component.

A Partial topology is a topology with only symbolic connections and between input and output. Connections in a partial topology are defined but not fully negotiated. Thus, additional components may need to be inserted into the topology in order to actually process the multimedia data. Partial topologies, in one embodiment, can be fully specified or not. A fully specified topology is a topology that describes every component relationship, but with all connections guaranteed to be successful when the media types are negotiated and objects are instantiated. The core MF objects in a fully-specified-yet-partial topology may not be instantiated yet. A fully specified topology is only different from a fully loaded topology by whether the objects are loaded or not. Each object in a fully loaded (not fully specified) topology is instantiated and each component is ready for processing. To save memory, a full topology can be reduced to a partial topology that is fully specified with objects that have been unloaded for memory saving purposes or for other reasons. The connections between nodes in an embodiment can have index-based connections rather than requiring pin objects.

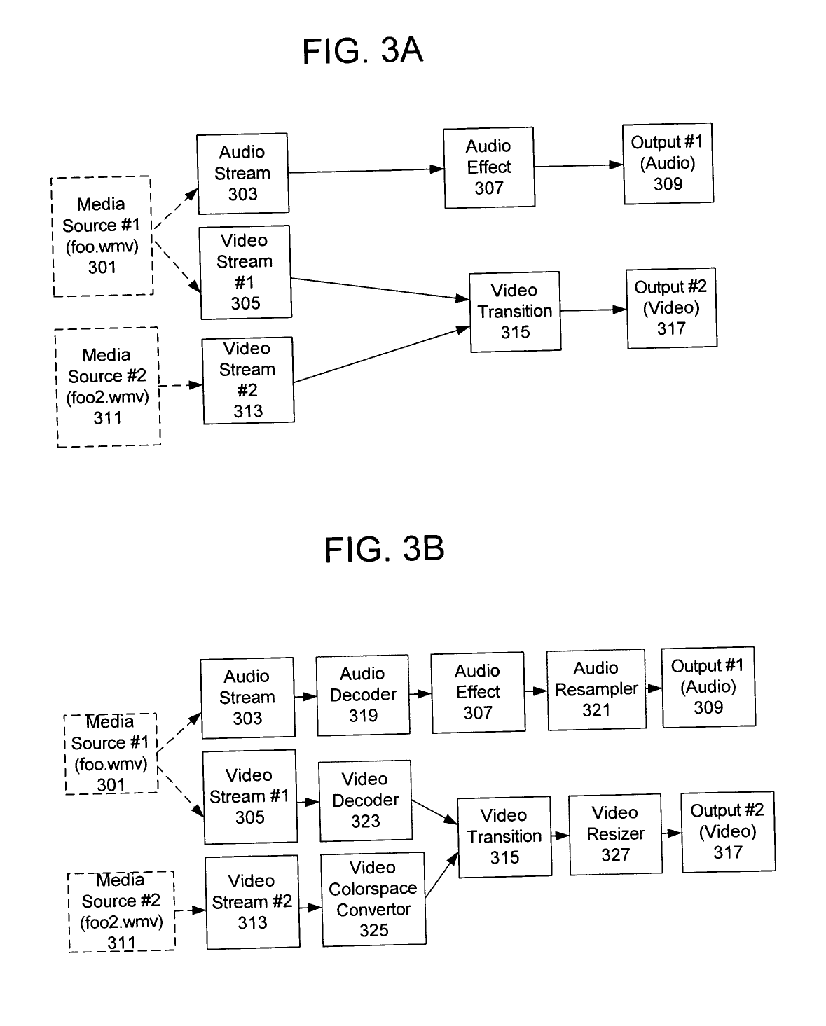

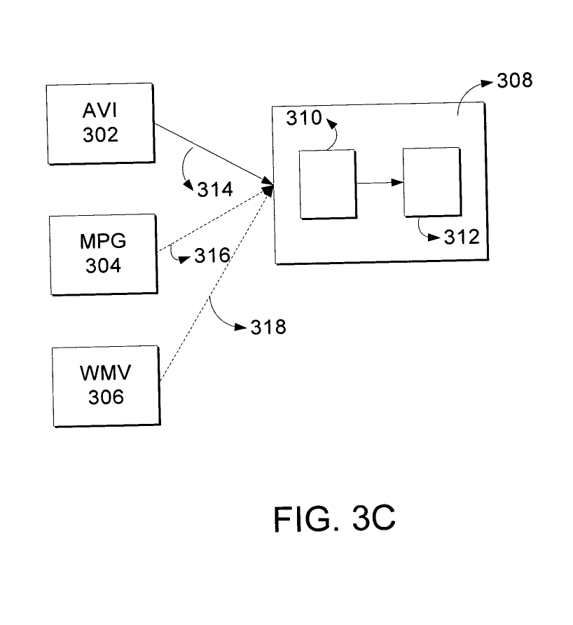

Referring now to FIGS. 3A and 3B, the partial and full topology concepts are exemplified. A fully specified topology guarantees that the data can be directly passed from one node to the next node. A partial topology contains topology nodes, but the data may not be able to be directly passed from one node to the next. For example, a partial topology could consist of only two nodes, a source node which will provide compressed data and a sink node which requires uncompressed data. In order to become a fully-specified topology, a decompressor node would need to be inserted between the two nodes. Also, for partial topology, a node may only contain enough information to instantiate an object. Therefore, objects therein may not need to be actually instantiated until the topology is resolved from a partial topology to a full topology. Because object instantiation can be delayed until the topology is resolved, an object or objects specification (it's abstract) can be shared among different topologies, given the restriction that only one topology is actively in use. For example, an effect node can be specified in several topologies by a CLSID (unique value). As long as only one topology is being used at a time, this CLSID can be mapped to one and only one currently running instantiated MF core object which does the processing.

FIG. 3A illustrates a partial topology showing media source #1 301 and media source #2 311. Media source #1 is shown coupled to produce audio stream 303 and video stream #1 305. Audio stream 303 is coupled to audio effect 307. Audio effect 307 is coupled to output #1 (audio) 309. Media source #2 311 is coupled to produce video stream #2 313. Video stream #1 305 and video stream #2 313 are both coupled to video transition 315. Video transition 315 is coupled to output #2 (video) 317. FIG. 3A is a partial topology because data cannot be passed from audio/video streams 303, 305, and 313 to block 307 and 315, respectively, without appropriate decoders/converters and the like. Likewise, data cannot be passed to outputs 309 and 317 without appropriate resizing/resampling.

FIG. 3B illustrates a full topology illustrating the same components shown in FIG. 3A, but including additional components to enable passing of data. Thus, audio stream 303 is shown coupled to audio decoder 319; and audio decoder 319 is coupled to audio effect 307. Audio effect 307 is coupled to audio resampler 321, which is further coupled to output #1 (audio) 309. Video stream #1 305 is coupled to video decoder 323, which is coupled to video transition 315. Video stream #2 313 is coupeld to video colorspace converor 325, which is coupled to video transition 315 as well. Video transition 315 is coupled to video resizer 327, which is further coupled to output #2 (video) 317. Importantly, FIG. 3B illustrates a topology in which data can be passed from media sources #1 and #2 301 and 311 through to outputs #1 and #2 309 and 317.

FIG. 3C illustrates a segmented topology, including Audio-Video Interleaved (AVI) signal 302, Motion Picture Experts Group (MPG) signal 304 and WMV 306. Block 308 illustrates a segmented topology node, including a two-node topology including nodes 310 and 312. Nodes 310 and 312 can perform a function, such as adding a grey scale to a media stream or the like. The nodes 310 and 312 make up a partial topology. Within nodes 310 and 312 are objects that need to be instantiated when the partial topology is connected to additional nodes to create a full topology. The segmented topology node 308 is shown connected to source node 302, representing an AVI input signal 302 via connection 314. According to an embodiment, a timeline or other mechanism can provide that segmented topology node 308 connect to MPG 304 or WMV 306 sequentially after AVI 302. Advantageously, the partial topology of nodes 310 and 312 can be re-used.

Segmented topology node 308 is a type of node that can have any number of inputs, and any number of outputs. The purpose of a segment topology node is to simplify the partial topology building process by enabling applications to build a topology as blocks of segment nodes, and by swapping, removing or replacing segmented topology nodes. Additionally, by using segments, topology loading performance is efficient. Segment topology nodes are the only type of node that does not correspond to a core-layer component; rather they correspond to a sub-topology. This concept is strictly for convenience; a topology containing segment topology nodes can always be reduced to an equivalent topology without segment topology nodes.

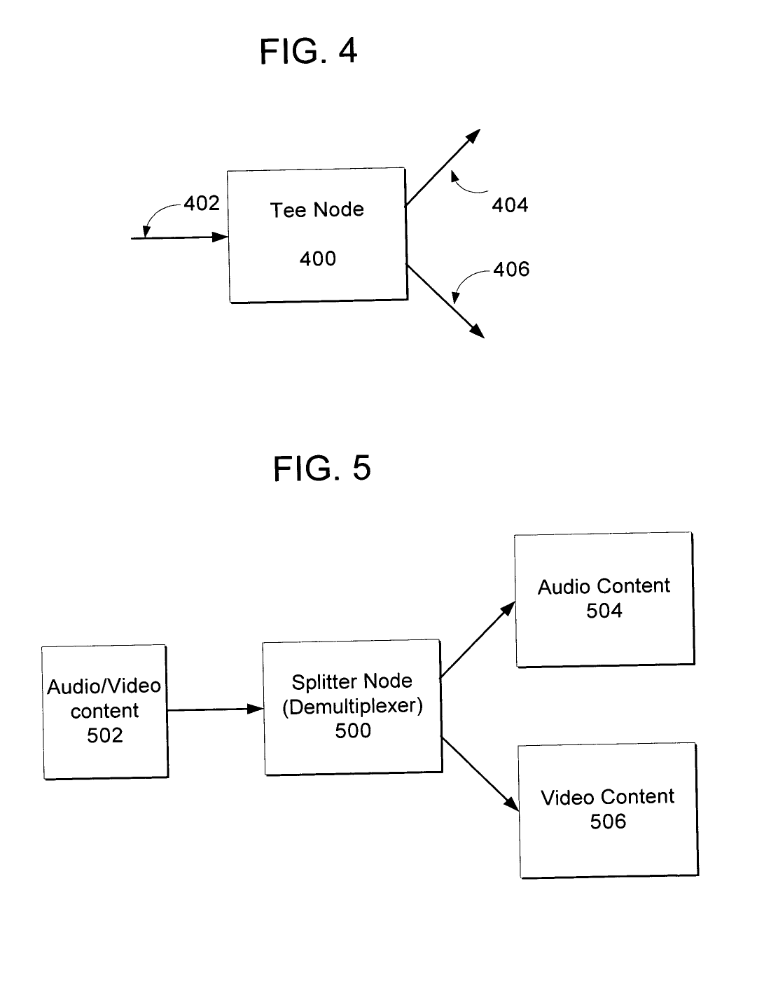

Referring now to FIG. 4, one type of node according to an embodiment is a tee node 400, in which an incoming stream 402 can be output from the node 400 via a primary stream 404 or a secondary stream 406. Primary stream 404 is connected to a 128 bit buffer 408 WMV, secondary stream 406 is connected to a 56 bit buffer. Alternatively, secondary stream 406 can be connected to a preview buffer 410. Preview buffer 410 can be a lossy type buffer by allowing dropped samples. The tee node provides multiple copies. A tee node can behave with logic. For example, if a user is capturing to a file and previewing at the same time, then the output of the tee node that goes to the preview component can be marked as discardable. Media processor 220 passes a lesser number of frames to the discardable stream as compared to the number of samples passed to the stream for which output is to a file.

Another type of node is a demultiplexer node. Referring to FIG. 5 illustrates a demultiplexer node 500. A source node 502 provides audio and video data to demultiplexer node 500. Demultiplexer node 500 outputs to a video decoder 504 and to an audio decoder 506. By splitting the data into audio and video data, the decoders can pass the data to audio transforms or video transforms respectively.

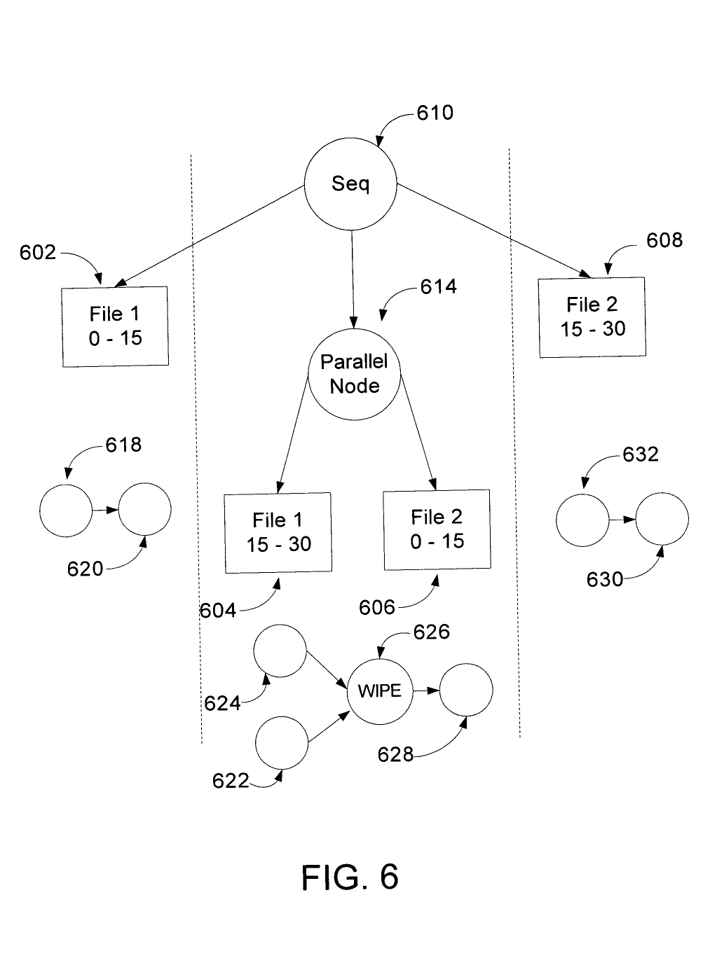

Referring now to FIG. 6, a block diagram is shown that illustrates a timeline source configuration and the corresponding partial topologies at all positions in the timeline. The timeline describes a multimedia presentation which changes through time, and the timeline source is responsible for creating the correct partial topologies for the timeline. In the example, files 1 and 2 are shown. Block 602 illustrates file 1 for time 0 to 15. Block 604 illustrates file 1 for time 15 to 30. Block 606 illustrates file 2 for time 0 to 15, and block 608 illustrates file 2 for time 15 to 30. Node 610 illustrates a sequence node for a timeline source, each file block 602 and 608 are played in sequence. Node 614 illustrates a parallel node and each file block 604 and 606 are played in parallel. Also shown in FIG. 6 are associated topologies for each file block 602-608 represented above the respective topology. For example, connected nodes 618 and 620 represent a partial topology associated with block 602. Node 618 represents a source input and node 620 represents an output sink. Likewise, nodes 622-628 represent nodes in a partial topology associated with block 604, 606 and node 614 above. Parallel node 614 is shown by having nodes 622 and 624 both coupled to node 626 perform a “wipe.” Node 628 illustrates a sink for the topology. Nodes 632 and 630 illustrate a simple topology with a source 632 and sink 630 associated with block 608.

FIG. 6 illustrates how a timeline source generates topologies. Files 1 and 2 can represent video files, for example, that can be played as picture in picture or in another configuration, such as file 1 and then file 2. The resulting topologies illustrate that if Files 1 and 2, both 30 seconds in length, are supplied to a timeline source as shown, the output would present 15 seconds of file 1 followed by 15 seconds of file 2. The wipe illustrated could also be an effect, such as a picture in picture or the like.

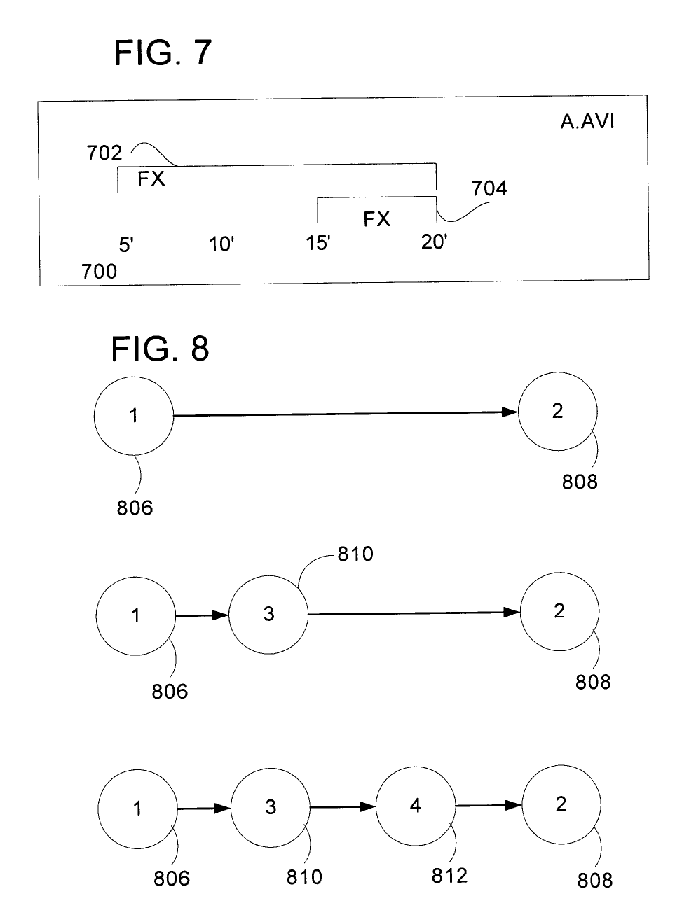

Referring back to FIG. 2 in combination with FIGS. 7 and 8, in one embodiment, media session 240 provides scheduling for files using unique identifiers. The unique identifiers can by universal resource locator type addresses (URLs), or other appropriate non-random type identifiers. More specifically, FIG. 7 illustrates a likely media timeline 700 showing effects (FX) 702 and 704 occurring during times 5 to 20 seconds and 15 to 20 seconds, respectively. The resulting topologies are illustrated in FIG. 8. As shown, each node has a unique identifier associated therewith. Source node 806 with unique identifier 1 is first coupled to sink node 808 with identifier 2. Nodes 806 and 808 make up a partial topology in that it is neither loaded nor resolved. Next, media session 240 determines that a decoder is necessary for the topology and decoder 810 is added to the topology with unique identifier 3. Thus, the topology is now node 806 followed by node 810 and then node 808. To provide a fully loaded topology, media processor operates on the topology to provide an effect appropriate for the time 5 second to 10 seconds. The resulting topology therefore is shown including node 812 with unique identifier 4.

According to an embodiment, the resulting topology can be reused using the unique identifiers to create a topology appropriate for time 15 seconds to 20 seconds. More specifically, since nodes 806, 810 and 808 can be reused, node 812 can be swapped out for an appropriate effect if a different effect is desired for time 15 seconds to 20 seconds. Moreover, if another topology has been created with a desired effect, that topology will include a unique identifier associated with the effect and that unique identifier can be located, found and inserted into a current topology. Any of the nodes can be swapped out for other nodes using the unique identifiers. Thus, for example, if the same effects are desired for another file, the source node 1 806 can be swapped out.

The different topologies illustrated in FIG. 8 show that once a topology is specified, it can be static until modified by an external object. Topology embodiments described allow callers to traverse a whole topology via symbolic connection mechanisms and enumerate connected inputs and outputs on each node. Thus, to build and use topologies, an embodiment is directed to methods and data structures that enable a user, such as a developer, to build and use topologies.

An embodiment is directed to methods that allow a user to pre-specify which object to use prior to a topology being resolved or used by media processor 220. The user can set either static or dynamic properties for an object. To allow a user of a timeline to set static and varying properties on an object that hasn't been created yet, for example, for resource management reasons, one embodiment is directed to allowing a user to set the properties on a proxy object, or properties object. A proxy object can be created, loaded with properties, then follow the created object through a topology and be used by media processor 220 to set properties on the object for different frames as directed.

Other user methods provide a user with different abilities including: to remove nodes; to create blank nodes; to validate a topology; to query what node is connected to a given input stream or output stream; to enable a user to set the output media type of a given output stream for a node; to determine and name a topology descriptor of the currently loaded topology; to make a current node a copy of the node that is passed in as input; set an output stream identifier provided on an output node; to set a media source directly and provide a descriptor; to indicate to media processor 220 which of a plurality of output streams should wait for a request before processing the request from the remaining outputs; and to identify a discardable stream with a flag so that media processor 220 does not necessarily have to provide all received samples that are input to the output stream of a tee node.

Other methods are internal for a topology to function. For example, an acceptable media type can be a partial media type that provides information for a tee node as to where the node should be positioned in the fully resolved topology. If an acceptable media type is set as an uncompressed media type and the source is providing compressed data, then the tee node will be inserted after a decompressor. If the acceptable media type is set as a compressed media type, and the source provides compressed data, then the tee node will be inserted before the decompressor. Another internal method includes setting a flag identifying a topology as “dirty” so that further resolving will be performed. Note that the topology lets a user or application specify the data required by a topology, but does not perform the functionality, such as inserting tee nodes and the like. Rather, topology loader 250 can be configured to perform the actions required via a topology API.

The topology descriptor which can be set by a user allows interaction between topologies and a user. For example, using the topology descriptor, a user can (1) find how many inputs or output streams are associated with a particular topology; (2) find out the major type of each input/output stream for a topology; and (3) select or deselect a particular stream in a topology. Identifying the major type of input and output stream benefits a user by enabling the user to make consistent connections between topologies.

In one embodiment, the topology descriptor is a collection of topology stream descriptors. Each topology stream descriptor can be identified by a stream identifier. Each stream in the topology can be turned on or off by using SelectStream/DeselectStream. In the embodiment, a topology is not built for streams that are deselected. A user can determine the number of input stream descriptors for the topology from which the topology descriptor was obtained.

The above methods and commands can be implemented as an API for multimedia data streams. The topology API includes a set of interfaces, data structures and events for representing a topology and topology loader of multimedia data. The API allows the consumer to use stream data such as digital video data in a uniform manner to generate elementary stream data such as audio and video (compressed or uncompressed). The API allows different topologies to be used as independent components. The API reduces the need for the large number of API's for filters and a given filter no longer needs to be capable of interfacing to the API for every filter to which it might attach in systems where legacy filters are not supported.

The API includes a data structure to identify the type of topology. The syntax for the topology type is:

```
MF_TOPOLOGY_TYPE
typedef enum MF_TOPOLOGY_TYPE
{
  MF_TOPOLOGY_OUTPUT_NODE,
  MF_TOPOLOGY_SOURCESTREAM_NODE,
  MF_TOPOLOGY_TRANSFORM_NODE,
  MF_TOPOLOGY_TEE_NODE,
  MF_TOPOLOGY_SPLIT_NODE,
  ME_TOPOLOGY_SEGMENTTOPOLOGY_NODE,
  MF_TOPOLOGY_MUX_NODE,
  MF_TOPOLOGY_MILRENDER_NODE,
} ME_TOPOLOGY_TYPE;
```

The interface that retrieves the type of node is IMFTopologyNode::GetNodeType( ). The data structure MF_TOPOLOGY_OUTPUT_NODE indicates the topology node is for output. An output node can be structured to have only inputs, no outputs. An output node's object can support IMFStreamSink, which is a method for the data stream output. The data structure MF_TOPOLOGY_SOURCESTREAM_NODE indicates the topology node is for specifying an input. This type of node should only have outputs, no inputs. A source node is expected that an IUnknown * object supports IMFMediaSource, which is a method for data input. The data structure MF_TOPOLOGY_TRANSFORM_NODE indicates that a node is for transforms, such as effects, composition, encoder, decoder, or other purpose media objects. A transform node can have both inputs and outputs. A transform node can be expected to have a IUnknown * object support a IMFTransform interface method. The data structure MF_TOPOLOGY_TEE_NODE indicates the node is for splitting the input to multiple outputs, which are the same as input. The tee node itself does not contain any actual objects, i.e., user doesn't need to set CLSID or object to this node when building partial topology. The actual splitting work is done in the media processor. The data structure MF_TOPOLOGY_SPLIT_NODE indicates the node is for a splitter object. The splitter type of node has one input and multiple outputs. In one embodiment, both a splitter and multiplexer and other transforms are identified as MF Transforms, with either the same major type as an output with respect to an input or a different major type as an output. The data structure MF_TOPOLOGY_SEGMENTTOPOLOGY_NODE indicates the node is for a segment topology. The segment type of node can have any number of inputs, and any number of outputs. The object set onto this node should be an IMFTopology object. The purpose of this node is to simplify the partial topology building process by enabling applications to build topology as blocks, and by simply swap/remove/replace blocks. Also, this will also help with topology loading performance.

The data structure MF_TOPOLOGY_MUX_NODE can have multiple inputs and a single output. The data structure functions to interleave audio, video and other streams into an interleaved stream.

The data structure MF_TOPOLOGY_MILRENDER_NODE can have multiple inputs and one output. The data structure functions to use a composition engine to compose multiple video streams to form one single video stream.

The topology API also includes an interface called IMFTopologyNode. The API includes one or more commands with the following syntax:

```
interface IMFTopologyNode : IUnknown
{
  HRESULT SetObjectID( const GUID *pidObject );
  HRESULT GetObjectID( GUID *pidObject );
  HRESULT SetObject( IUnknown *pObject );
  HRESULT GetObject( IUnknown **ppObject );
  HRESULT GetMetadata( [in] REFIID riid, [out] IUnknown**
ppUnkObject);
[MW1]
  HRESULT SetCacherObject( IUnknown *pObject );
  HRESULT GetCacherObject( IUnknown **ppObject );
  HRESULT GetNodeType( MF_TOPOLOGY_TYPE *pType );
  HRESULT GetTopoNodeID( TOPOID * pID );
  HRESULT SetProjectStartStop( LONGLONG cnsStart,
        LONGLONG cnsStop );
  HRESULT GetProjectStartStop( LONGLONG *pcnsStart,
        LONGLONG *pcnsStop );
  HRESULT GetInputCount( long *pcInputs );
  HRESULT GetOutputCount( long *pcOutputs );
  HRESULT ConnectOutput( long OutputIndex,
        IMFTopologyNode *pInputNode,
        long InputIndex );
  HRESULT GetInput( long InputIndex,
        IMFTopologyNode **ppOutputNode,
        long *pOutputIndex );
  HRESULT GetOutput( long OutputIndex,
        IMFTopologyNode **ppInputNode,
        long * pInputIndex );
  HRESULT SetOutputPrefType( long OutputIndex,
        IMFMediaType * pType );
  HRESULT GetOutputPrefType( long OutputIndex,
        IMFMediaType ** ppType );
  HRESULT SetMajorType( GUID guidType );
  HRESULT GetMajorType( GUID* pguidType );
  HRESULT CloneFrom( IMFTopologyNode* pNode );
  HRESULT SetInputCount( long cInputs );
  HRESULT SetOutputCount( long cOutputs );
  HRESULT SetStreamDiscardable( long lOutputIndex, BOOL
bDiscardable );
  HRESULT GetStreamDiscardable( long lOutputIndex, BOOL*
pbDiscardable );
  HRESULT SetOptionalFlag(BOOL bOptionalFlag );
  HRESULT GetOptionalFlag(BOOL* pbOptionalFlag );
};
```

The command within the interface called IMFTopologyNode shall now be further explained. The command: (Get)SetObjectID(const GUID * pidObject) can be set by a user and used to allow a user to specify the CLSID of the object to create and use, prior to the topology being resolved (loaded) by the topology loader 250. This is useful only for transforms. In an embodiment, the Get method only works if a) Set has already been called, or b) the object has had SetObject called on it, and that object supports Ipersist (which is necessary to retrieve the CLSID).

The command (Get)SetObject(Iunknown * pObject) can be set by a user and used by media processor 220. The command allows the user to pre-specify which object to use prior to the topology being resolved or used by the media processor 220. The command is useful for all nodes but tee nodes.

For source nodes, the pObject should be an IMFMediaSource *. For transforms, it should be an IMFTransform interface *, and for sinks, it should be an IMFStreamSink*. For partial topologies that need to be resolved, the output node must be set to a valid IMFStreamSink, and the stream sink can be configured to support GetMediaTypeHandler( ) or the equivalent. The MediaTypeHandler can be used by the topology loader 250 to help resolve the topology to the output node's satisfaction.

The command (Get)SetPropsObject(Iunknown * pObject) is set by the user or by a project reader and used by media processor 220. In one embodiment, the pObject * is an IMFPropertyStoreProxy * object that allows setting static and dynamic properties on an object.

To allow the user of a partial topology creation component to set static and varying properties on an object that hasn't been created yet (for resource management reasons), the Timeline allows setting the properties on a proxy object, called “the props object”. This object is created, stuffed with properties, then follows the created object down into the Topology and is used by the Media Processor to set properties on the object for every frame tick.

The command (Get)SetCacherObject(Iunknown * pObject) is a command used by media processor 220 to allow media processor 220 to store a kind of state associated with a particular topology node. The command can operate on any Iunknown object. The command can be configured to be used only by media processor 220. In one embodiment, a schedule object can be configured to pair the cacher along with the object when it resource-manages the object. The schedule object can also be incorporated into other components as system requirements dictate. The cacher object can be stored in the object cache along with the object.

The GetNodeType command returns an enum from MF_TOPOLOGY_TYPE based on the node type. The GetTopoNodeID command is set by a constructor on a node and used to uniquely identify a topology node. The identifier is set when the topology node is created, and stays the same no matter what object is set in the node's SetObject. The unique ID is used by the Topology loader 250 to find a node in a list. The command (Get)SetProjectStartStop(MFTIME rtStart, MFTIME rtStop) is used by media processor 250. The command provides the project time during which the node is active. The value is set, and media processor 220 uses the value. The project start/stop time ranges can extend beyond the current topology start/stop times.

The commands GetInputCount and GetOutputCount return how many inputs or outputs have been connected to a node.

The command ConnectOutput(long OutputIndex, . . . ) is called by a user to connect a node to another node. If an output node stream is already connected, it is unlinked first. The command Param long OutputIndex: provides which output node stream to connect. The command Param IMFTopologyNode * pInputNode: provides which input node to connect it to, which cannot be NULL. The command Param long InputIndex: provides which input stream on pInputNode to connect to. The command GetInput(long InputIndex, . . . ) is a command that queries what node is connected to the given input stream of a node. If a node doesn't exist, out values are filled with 0's and an error is returned. The command Param long InputIndex: is a command that identifies an input stream. The command Param IMFTopologyNode ** ppOutputNode: identifies the connected node, if any. The command Param long * pOutputIndex identifies an output stream of ppOutputNode to which a node is connected. The command GetOutput) is a command that queries what node is connected to the given output stream of a node. If a node doesn't exist the call fails. The command (Get)SetOutputPrefType(long OutputIndex, . . . ) is set by a user and used by topology loader 250. The command is a call to set the output media type for the given output stream on a node. The set method should only be called on a partial topology. The command Param long OutputIndex: provides which stream index to set an enforced type. The command Param IMFMediaType * pMediaType: provides a current full media type to enforce on the output stream. The command (Get)SetMajorType( ) is set by a user and used by topology loader 250 to set the major type of a current stream. The major type is used by topology loader 250 to obtain the topology descriptor of the currently loaded topology. The command CloneFrom is used by a user to make a current node a copy of the node that is passed in as input. The command SetInputCount is used by a user to set the number of input streams for the current node. The command SetOutputCount is used by a user to sets the number of output streams for the current node. The command SetStreamDiscardable is set by a user and used by media processor 220. More particularly, if a streamdiscardable flag is set to true then media processor 220 does not have to provide all the samples that it receives on its input to the output stream of node marked as discardable. For example, a user capturing to a file and previewing at the same time, with the output of the tee node that goes to the preview component can be marked as discardable. In that case, media processor 220 will pass a lesser number of frames to this stream as compared to the number of samples passed to the stream on which output to file is being done.

The command GetStreamDiscardable is used by media processor 220 to retrieve the discardable flag status on the output stream of a tee node. The command SetOptionalFlag is used topology loader 250 to set the optional flag on a topology transform node to indicate to only apply the node in topology if the node fits.

The command GetOptionalFlag is used by topology loader 250 to retrieve the optional flag setting on the topology node. The topology API further includes another interface, IMFOutputTopologyNode. The syntax for the interface is as follows:

```
interface IMFOutputTopologyNode : IUnknown
{
  HRESULT SetStreamID( long StreamID );
  HRESULT GetStreamID( long * pStreamID );
};
```

The interface, IMFOutputTopologyNode operates with two commands. The first command, SetStreamID(long StreamID) is called by either a user or media engine 260 to set the output stream ID provided on an output node. The command can be called for every output node before the topology is given to media processor 220.

The command GetStreamID(long * pStreamID) is called by a user and indirectly called through media processor 220. The media processor 220, when asked for an output stream's identifiers, will internally forward the command to an associated output node's GetStreamID.

The topology API further includes an interface, IMFSourceStreamTopologyNode. The syntax for the node is as follows:

```
interface IMFSourceStreamTopologyNode : IUnknown
{
  HRESULT SetSourceAndDescriptor( IMFMediaSource * pSource,
    IMFStreamDescriptor * pDescriptor );
  HRESULT GetSourceAndDescriptor( IMFMediaSource ** ppSource,
    IMFStreamDescriptor ** ppDescriptor );
  HRESULT GetMediaStart( LONGLONG * pVal );
  HRESULT SetMediaStart( LONGLONG Val );
};
```

The commands for the interface shall now be described. The command (Get)SetSourceAndDescriptor( . . . ) is set by a user and used by topology loader 250 and can be used instead of SetURLAndIndex to set the media source directly that a user wants o use, plus the descriptor. The topology loader 250, when fully loading a topology, will create a media stream based on the given descriptor.

The data structure Param IMFMediaSource * pSource: is a command that can operate as a “live” source pointer to use Param IMFStreamDescriptor * pDescriptor:, which identifies the descriptor to use.

The command (Get)SetMediaStart(MFTIME rtStartOffset) is set by a user and used by media processor 220 to set the media start offset for a media source, once created. Media processor 220 uses the command to skew the incoming timestamps from sample to “project time”. The command is important for mixing things at the right time.

Another interface included in the topology API is called IMFTeeTopologyNode. The syntax for the interface is as follows:

```
interface IMFTeeTopologyNode : IUnknown
{
  HRESULT SetAcceptMediaType( IMFMediaType*
  pPartialMediaType );
  HRESULT GetAcceptMediaType( IMFMediaType**
  ppPartialMediaType );
  HRESULT SetPrimaryOutput( long nPrimary );
  HRESULT GetPrimaryOutput( long* pnPrimary );
};
```

Another interface included in the topology API is called IMFTeeTopologyNode. The IMFTeeTopologyNode interface can include two commands including (Get)SetAcceptMediaType . . . ) and (Get)SetPrimaryOutput . . . ).

The (Get)SetAcceptMediaType . . . ) call can be set by user and used by topology loader 250. The acceptable media type is a partial media type that provides a hint to the tee as to where it should be positioned in the fully resolved topology. In case the acceptable media type is set as an uncompressed media type and the source is providing compressed data, then the tee will be inserted after the decompressor. If the acceptable media type is set as a compressed media type and the source provides compressed data, then the tee will be inserted before the decompressor. The (Get)SetPrimaryOutput . . . ) call is set by a user and used by media processor 220. The primary output is an indication to media processor 220 about which of the output streams that media processor 220 should wait to get a request on before processing the request from the remaining outputs.

Another interface included in the topology API is the IMFSegmentTopologyNode interface. A segment topology node contains a topology within. Such a node holds a pointer to the topology and acts like any other node. The segment topology node has a set of input pins and output pins to which other nodes in the topology can connect. Once a topology is set on the segment node, the node computes the input and output node count. Any modifications made to the topology through AddNode/RemoveNode/Connect will not cause a change in the input and output nodes of a topology. Thus, it is necessary that the user defines the connections for the topology node to be set into a topology completely before setting it onto the segment node.

The interface has the following syntax:

```
interface IMFSegmentTopologyNode : IUnknown
{
  HRESULT SetSegmentTopology( IMFTopolgy* pTopology );
  HRESULT GetSegmentTopology( IMFTopology** ppTopology );
  HRESULT SetDirty( BOOL bDirty );
  BOOL IsDirty( );
  BOOL GetActualOutputNode( long lIOutputIndex,
IMFTopologyNode** ppActualNode, long* plNodeOutputIndex );
  BOOL GetActualInputNode( long lInputIndex, IMFTopologyNode**
ppActualNode, long* plNodeInputIndex );
};
```

The commands for the segment topology interface include (Get)SetSegmentTopology . . . ), which is set by a user and used by topology loader 250. The command is used to set a topology onto a segment topology node. Another command is (IsDirty/SetDirty . . . ), which is used by topology loader 250 to set a dirty flag on the topology that is inside the current segment topology and used to determine whether the topology needs to be resolved again. The command GetActualOutputNode is used by a user to determine a base level node (non-segment node) that is connected to an output stream at index lOutputIndex of the segment node. The command GetActualInputNode is used by a user to determine the base level node (non-segment node) that is connected to a input stream at index lInputIndex of the segment node.

Another interface included in the topology API is IMFSplitTopologyNode, which has the following syntax:

```
interface IMFSplitTopologyNode : IUnknown
{
  HRESULT SetInputMediaType( IMFMediaType*
  pPartialMediaType );
  HRESULT GetInputMediaType( IMFMediaType**
  ppPartialMediaType );
  HRESULT InitOutputDescriptor(IMFPresentationDescriptor*
pPresentationDescriptor );
  HRESULT GetOutputDescriptor(IMFPresentationDescriptor**
ppPresentationDescriptor );
};
```

The command (Get)SetInputMediaType . . . ) is set by a user and used by topology loader 250 to set the input media type for the input stream of the splitter node. The media type that is set can be the interleaved media type obtained from the interleaved (DV/mpeg2) source.

The (Init)GetOutputDescriptor . . . ) command is set by the user and used by topology loader 250 to set/retrieve the output descriptor set on the splitter object within the node. During the topology negotiation process, the presentation descriptor is updated and streams are selected/deselected based on the output nodes connected to the outputs of the splitter.

The topology API further includes the interface IMFMilRenderTopologyNode, which has the following syntax:

```
interface IMFMilRenderTopologyNode : IUnknown
{
  HRESULT SetInputMediaType( long lInputIndex, IMFMediaType*
pPartialMediaType );
  HRESULT GetInputMediaType( long lInputIndex, IMFMediaType**
ppPartialMediaType );
  HRESULT SetOutputMediaType(IMFMediaType* pPartialType );
  HRESULT GetOutputMediaType(IMFMediaType* pPartialType );
};
```

The command (Get)SetInputMediaType . . . ) is set by a user and used by both topology loader 250 and media session 240 to set the input mediatype for the input stream of the MilRender node.

The command (Get)SetOutputMediaType . . . ) is set by the user and also used by topology loader 250 and media session 240 to set the output mediatype for the MilRender node. MilRender Node can have multiple input streams, and only one output stream.

The topology API includes a IMFTopology interface with the syntax:

```
interface IMFTopology : IUnknown
{
  HRESULT GetTopologyID( TOPOID * pID );
  HRESULT GetState( MF_TOPOLOGY_STATE *pState );
  HRESULT AddNode( IMFTopologyNode *pNode );
  HRESULT RemoveNode( IMFTopologyNode * pNode );
  HRESULT GetNodeCount( WORD *pcNodes );
  HRESULT GetNode( WORD wIndex,
        IMFTopologyNode **ppNode );
  HRESULT Clear( );
  HRESULT GetTopologyDescriptor( IMFTopology**
ppTopologyDescriptor );
  HRESULT Load( WCHAR* wszFileName );
  HRESULT Save( WCHAR* wszFileName );
  HRESULT CloneFrom( IMFTopology* pTopology );
};
```

The command GetTopologyID(TOPOID * pID) is used to uniquely identify a topology in a list of topologies and to identify which topology in a list matches one which is being asked about by media processor 220 and can be an ID determined when the topology is created.

The GetState(MF_TOPOLOGY_STATE * pState)

```
typedef enum
{
  MF_TOPOLOGY_STATE_PARTIAL = 0x00000001,
  MF_TOPOLOGY_STATE_LOADING = 0x00000002,
  MF_TOPOLOGY_STATE_LOADED = 0x00000003,
  MF_TOPOLOGY_STATE_FULL = 0x00000004
} MF_TOPOLOGY_STATE;
```

The GetState(MF_TOPOLOGY_STATE * pState) returns the state the Topology is in. The state can be determined by the components such as topology loader 250 that have operated upon the topology. The different states include a Partial topology, which is a topology that has specified the general flow of the bits, but all the sources and DMO's will not automatically interface to each other if they were loaded. For example, codecs, resizers, and format changers, may be missing in the topology. Another state is a loading topology in which the topology loader 250 is actively engaged in turning the topology from Partial or Full to Loaded. Another state is a loaded topology, in which each source or DMO in the topology has already been loaded, and contains a IUnknown pointer to the object, but the media types have not necessarily been agreed upon. A full topology is one in which each source or DMO is guaranteed to agree upon a common media type by which to communicate. The media types have all been agreed upon and the full topology is ready to process by the Media Processor.

The AddNode(IMFTopologyNode * pNode) command is called by a user and called on for a partial topology, and adds a node to a topology tree. The AddNode should not be called on a non-partial topology unless the user is very careful about how to build fully-loaded topology trees. The RemoveNode(IMFTopologyNode * pNode) command is called by a user to remove a node from a topology. The GetNodeCount( ) command is called by a user to determine the count of nodes in a current topology. The GetNode( ) command is called by a user to retrieve a node at position wIndex in the current topology. The Clear( ) command is called by a user to remove all nodes in the current topology. The GetTopologyDescriptor( ) command is called by a user to retrieve the topology descriptor for a current topology. The Load( ) command is called by a user to load a topology from, for example, an XML file. The Save( ) command is called by a user to save the current topology to an XML file. The CloneFrom( ) command is called by a user to make a current topology a copy of another topology passed in as pTopology.

The interface IMFTopologyHelper is another interface within the topology API and has the syntax:

```
interface IMFTopologyHelper : IUnknown
{
  HRESULT GetSourceNodeCollection( IMFCollection**
  ppSourceNodes );
  HRESULT GetOutputNodeCollection( IMFCollection**
  ppOutputNodes );
};
```

The IMFTopologyHelper commands include GetSourceNodeCollection(IMFCollection** ppSourceNodes), which is used by a caller module, such as media session 240 or an application to discover all the source nodes in current topology. The function can be a helper function to save a caller from having to enumerate through the whole topology.

The GetOutputNodeCollection(IMFCollection** ppOutputNodes) command is also used by a caller such as media session 240 or an application to discover all the output nodes in current topology. The command is a helper function to save a caller from having to enumerate through the whole topology.

The topology API also includes some basic commands such as MFCreateTopology for a user to create a blank topology and MFCreateTopologyNode to create a blank topology node of a certain type. The topology node can already be added but be unconnected.

The parameters for the new node can include: Param IMFTopology * pTopo: The Topology to be the parent of this node, Param MF_TOPOLOGY_TYPE NodeType: The type of node to create and Param IMFTopologyNode ** ppNode: The returned created node.

The topology API provides an interface called IMFTopologyDescriptor to allow a user to find out information about a topology. For example, the user may want to find out how many inputs or output streams a particular topology has; what the major type of each input/output stream is for thea topology, which could be used by the user for connecting topologies; and allow a user to select or deselect a particular stream in a topology.

The TopologyDescriptor is a a data structure that is a collection of Topologystream descriptors. Each TopologyStreamDescriptor is identified by a stream identifier. Each stream in the topology can be turned on or off by using SelectStream/DeselectStream. When a stream is deselected, the topology does not build using the streams that are deselected.

The syntax for IMFTopologyDescriptor is as follows:

```
interface IMFTopologyDescriptor : IUnknown
{
  HRESULT GetInputStreamDescriptorCount ([out] DWORD*
pdwDescriptorCount );
  HRESULT GetInputStreamDescriptorByIndex ([in] DWORD dwIndex,
[out] IMFTopologyStreamDescriptor** ppDescriptor );
  HRESULT GetOutputStreamDescriptorCount ([out] DWORD*
pdwDescriptorCount );
  HRESULT GetOutputStreamDescriptorByIndex
  ([in] DWORD dwIndex,
[out] BOOL* pfSelected, [out] IMFTopologyStreamDescriptor**
ppDescriptor );
  HRESULT SelectOutputStream([in] DWORD dwDescriptorIndex );
  HRESULT DeselectOutputStream ([in] DWORD dwDescriptorIndex );
};
```

The command GetInputStreamDescriptorCount is called by a user and returns the number of input stream descriptors for the topology from which the topology descriptor was obtained.

The command GetInputStreamDescriptorByIndex is called by a user and returns the input streamdescriptor at position dwIndex.

The command GetOutputStreamDescriptorCount is called by a user and returns the output streamdescriptor at position dwIndex.

The command GetOutputStreamDescriptorByIndex is called by a user and returns the output streamdescriptor at position dwIndex. The command also returns the current selected state of the stream at position dwIndex.

The command SelectOutputStream is called by a user and Enables the stream at position dwIndex. If stream is selected then topology is built for this stream.

The command DeselectOutputStream is called by a user to disable a stream at position dwIndex.

A related interface is IMFTopologyStreamDescriptor, which identifies the majortype and the streamid of the current stream. The syntax is as follows:

```
interface IMFTopologyStreamDescriptor : IUnknown
{
  HRESULT GetStreamIdentifier ([out] DWORD* pdwStreamIdentifier );
  HRESULT GetMajorType ([out] GUID* pguidMajorType );
};
```

The command GetStreamIdentifier is called by a user and returns the streamid of the current stream. The command GetMajorType is also called by a user and returns the majortype of the current stream.

In view of the many possible embodiments to which the principles of this invention can be applied, it will be recognized that the embodiment described herein with respect to the drawing figures is meant to be illustrative only and are not be taken as limiting the scope of invention. For example, those of skill in the art will recognize that the elements of the illustrated embodiment shown in software can be implemented in hardware and vice versa or that the illustrated embodiment can be modified in arrangement and detail without departing from the spirit of the invention.

A programming interface (or more simply, interface) may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

The term “interface” and programming interface can be interpreted as a conduit through which first and second code segments communicate. Additionally, an interface can include interface objects that function as either separate interfaces of the same system. Interface objects can be combined with a medium and also comprise an interface. An interface can further enable bi-directional flow and operate with or without interfaces on each side of the flow. Certain implementations of the invention described herein can include information flow in one direction or no information flow or have an interface object on one side. By way of example, and not limitation, terms such as application programming interface (API), entry point, method, function, command, subroutine, remote procedure call, and component object model (COM) interface, are encompassed within the definition of programming interface. Therefore, the invention as described herein contemplates all such embodiments as can come within the scope of the following claims and equivalents thereof.

We claim:

1. A method for providing a topology interface for a multimedia processing system, the method comprising:
receiving a plurality of media parameters identifying at least an identifier, a node type, a data type and a duration; and
in response, creating a topology capable of being passed to a media processor as an extensible symbolic representation of an intended media flow.

2. The method of claim 1 wherein the media parameters include one or more of a GetCacherObject, a GetNodeType, a GetTopoNodeID, a SetProjectStartStop, a GetProjectStartStop, a GetInputCount, a GetOutputCount, a ConnectOut, a GetInput, a GetOutput, a SetOutputPrefType, a GetOutputPrefType, a SetMajorType, a GetMajorType, a CloneFrom, a SetInputCount, a SetOutputCount, a SetStreamDiscardable, a GetStreamDiscardable, a SetOptionalFlag, and a GetOptonalFlag.

3. The method of claim 1 wherein the media parameters include a SetSourceAndDescriptor method that enables a topology loader to create a media stream based on a descriptor.

4. The method of claim 1 wherein the node type is a segment topology node type such that any modifications made to the topology to add, remove or connect nodes does not alter input and output nodes.

5. The method of claim 1 wherein the unique identifier enables sharing and reusing the nodes in a plurality of topologies.

6. The method of claim 4 wherein the segment topology node type is created via an IMFSegmentTopologyNode: IUnknown interface.

7. The method of claim 4 wherein the segment topology node type is created via an IMFSegmentTopologyNode: IUnknown interface including one or more of GetSegmentTopology(IMFTopolgy* pTopology), SegmentTopology(IMFTopology** ppTopology), SetDirty(BOOL bDirty), BOOL IsDirty( ), BOOL GetActualOutputNode(long lOutputIndex, IMFTopologyNode** ppActualNode, long* plNodeOutputIndex), and BOOL GetActualInputNode(long lInputIndex, IMFTopologyNode** ppActualNode, long* plNodeInputIndex).

8. A software architecture for providing a topology of media objects for a media processing system, the software architecture comprising:
at least a first component that identifies a connection between one or more nodes in the media processing system;
at least a second component that abstracts the connection between the nodes to enable the topology to be fully or partially specified independent of instantiation of the media objects; and
at least one application program interface to access the first and second components.

9. A method for providing an interface for a media processing system to provide a split topology node, the method comprising:
receiving a media type parameter;
receiving a descriptor parameter, the descriptor parameter configured to be updated and streams are selected/deselected based on one or more output nodes connected to the outputs of the split topology node.

10. The method of claim 9 wherein the interface operates on one or more commands including SetInputMediaType(IMFMediaType* pPartialMediaType), GetInputMediaType(IMFMediaType** ppPartialMediaType), InitOutputDescriptor(IMFPresentationDescriptor* pPresentationDescriptor), and GetOutputDescriptor(IMFPresentationDescriptor** ppPresentationDescriptor.

11. A computer readable medium on which is stored a topology function comprising:
a first input parameter representing a unique identifier;
a second input parameter representing a state of a topology;
a third parameter representing a descriptor for the topology;
a fourth parameter representing one or more characteristics about a node of the topology; and
executable instructions adapted to provide a topology capable of being passed to a media processor as an extensible symbolic representation of an intended media flow calculated based on at least one of the input parameters.

12. The computer readable medium of claim 11 wherein the unique identifier is input via a GetTopologyID(TOPOID * pID) command.

13. The computer readable medium of claim 11 wherein the state of the topology is input via a GetState(MF_TOPOLOGY_STATE *pState) command.

14. The computer readable medium of claim 11 wherein the state of the topology is one or more of a partial, loading, loaded, and full topology.

15. The computer readable medium of 14 wherein:
a partial topology state includes a state with a specified general flow of bits and one or more source and object is independent of automatic interfacing upon loading;
a loading topology state includes a state for which a topology loader is actively engaged in altering a topology from a partial state or full state to a loaded state;
a loaded topology state includes a state for which each source or object in the topology has already been loaded and contains a pointer to the object independent of agreement on one or more media types; and
a full topology state includes a state for which each source or object has an agreed upon media type and the topology is ready for processing.

16. The computer readable medium of claim 13 wherein the state of the topology is identified via a 32 bit hexadecimal value.

17. The computer readable medium of claim 11 wherein the descriptor is input via a GetTopologyDescriptor(IMFTopology** ppTopologyDescriptor) command.

18. The computer readable medium of claim 11 wherein the one or more characteristics about a node of the topology are input via one or more of a AddNode(IMFTopologyNode *pNode), RemoveNode(IMFTopologyNode * pNode), GetNodeCount(WORD *pcNodes), GetNode(WORD wIndex, IMFTopologyNode **ppNode), Clear( ) and CloneFrom(IMFTopology* pTopology) command.

19. A method for providing a segment topology node interface for a multimedia processing system, the method comprising:
receiving a first parameter defining one or more connections for the segment topology node;
receiving a second parameter identifying a pointer to a topology to which the segment topology node can connect; and
in response, creating the segment topology node as part of a topology that is incapable of alteration of input and output nodes to the segment topology node, the segment topology node being separately identifiable.

20. The method of claim 19 wherein the segement topology node is created by a topology loader operable through one or more of a SetSegmentTopology(IMFTopolgy* pTopology) command, a GetSegmentTopology(IMFTopology** ppTopology) command, a SetDirty(BOOL bDirty) command, a IsDirty( ) command, a GetActualOutputNode(long lOutputIndex, IMFTopologyNode** ppActualNode, long* plNodeOutputIndex) command and a GetActualInputNode(long lInputIndex, IMFTopologyNode** ppActualNode, long* plNodeInputIndex) command.

21. The method of claim 20 wherein the IsDirty and the SetDirty commands relate to a dirty flag on the topology that is inside the segment topology node to determine whether the topology requires resolving.

22. The method of claim 20 wherein the GetActualOutputNode command and the GetActualInputNode command are used to find a base level non-segment node connected to one of an output stream and an input stream at a predetermined index of the segment topology node.

23. A method for providing an interface for a multimedia processing system, the method comprising:
receiving a media processor parameter related to received media data;
receiving a timeline parameter related to timing of events to occur for performing media processing; and
receiving a topology parameter describing a flow for the received media data; and
in response, enabling a multimedia processing function via an extensible symbolic abstraction of media objects related to one or more of the media processor parameter, the timeline parameter and the topology parameter.

24. A method for identifying a flow of multimedia data through a collection of one or more media objects forming one or more nodes, the method comprising:
providing at least a first component that identifies a connection between one or more nodes;
providing at least a second component that abstracts the connection between the nodes to enable a topology to be fully or partially specified independent of instantiation of the media objects; and
providing an application programming interface to access at least one of the first and second components.

25. The method of claim 24 wherein the abstracting the connection between the nodes enables a delay between negotiating one or more media types for the topology and loading the media objects.

26. The method of claim 24 wherein the topology includes a segment topology node configured to provide an encapsulated topology that can be inserted and deleted from the topology, the segment topology node including one or more inputs and one or more outputs.

27. The method of claim 24 wherein the topology includes a tee node configured to provide a primary and secondary output stream therefrom, the tee node configured to respond to logic dictating a discardability of data output from one or more of the primary and the secondary output stream.

28. The method of claim 24 wherein the topology includes a demultiplexer node configured to split media into different types of media from a combined input.

29. The method of claim 28 wherein the combined input is an interleaved audio and video input, the demultiplexer node configured to split the audio from the video and provide at least an audio output and a video output.

30. The method of claim 24 wherein each node is identifiable via a unique identifier.

31. The method of claim 24 wherein the topology is identified by one or more topology descriptors enabling interaction between a user and the topology.

32. The method of claim 31 wherein the topology descriptor identifies a collection of topology stream descriptors, each topology stream descriptor identifying a media stream.
